(19) United States
(12) Patent Application Publication
(10) Pub. No.: US 2018/0093305 A1
(43) Pub. Date: Apr. 5, 2018

(54) USE OF ALKANE SULFONIC ACID FOR CLEANING IN THE SUGAR INDUSTRIES

(71) Applicant: ARKEMA FRANCE, Colombes (FR)

(72) Inventors: Jean-Alex LAFFITTE, Paul (FR); Bernard MONGUILLON, Bayonne (FR)

(73) Assignee: ARKEMA FRANCE, Colombes (FR)

(21) Appl. No.: 15/567,385

(22) PCT Filed: Apr. 8, 2016
(86) PCT No.: PCT/FR2016/050812

§ 371 Date: Oct. 18, 2017

(30) Foreign Application Priority Data
Apr. 21, 2015 (FR) 1553575

(51) Int. Cl. B08B 3/08; C23G 1/02; C11D 7/34; C11D 3/34; B08B 3/02

(52) U.S. Cl. CPC B08B 3/08; C23G 1/02; B08B 3/02; C11D 3/3409; C11D 7/34

(57) ABSTRACT

The present invention concerns the use of at least one alkane sulfonic acid of formula R—SO₃H, in which R represents a linear or branched saturated hydrocarbon chain comprising 1 to 4 carbon atoms, for cleaning solid deposits containing at least one aconitic acid salt. The invention also concerns a method for cleaning solid deposits containing at least one aconitic acid salt, using at least one alkane sulfonic acid.

The present invention relates to the field of the sugar industries, and more particularly the cleaning of facilities, comprising reactors, evaporators, containers, valves, pipes, tubes and the like, used during the production of sugar from natural plant materials, such as, for example, sugar cane and sugar beet.

During the production of sugar from plants, the sugar industry uses evaporators for concentrating the juices. During these concentrations, deposits appear over time. The accumulation of these deposits can cause disruptions to heat exchanges, or even prevent certain heat exchanges, which can lead to very significant economic consequences.

Thus, it is necessary to clean such deposits, when they become too great and they finally impair production yields. These cleaning phases mean that production interruptions are necessary, and consequently they must be as short as possible, while at the same time of course being as effective as possible.

At the current time, the cleaning of these deposits usually takes place chemically, with chelating agents, such as the sodium salt of EDTA, as described for example in application WO 2003/106735, or in acid medium, for example using hydrochloric acid, but also sulfamic acid or sulfuric acid, as described for example in “Chemical cleaning of sugar mill in evaporators” W. O. S. Doherty, Proc. Aust. Soc. Sugar Cane Technol., (2000), 22, 341-346.

These deposits encountered in the sugar industry generally consist of a type of scale formed from various elements, including salts, such as calcium carbonate, calcium oxalate, iron oxides, calcium phosphate, hydroxyapatite and aconitate, usually of calcium and/or of magnesium, as described in “Development of descriptor tools for the characterization of Australian sugar mill evaporator scale”, D. W. Rackemann et al., Proc. Int. Soc. Sugar Cane Technol., (2010), 27, 1-12.

The problem encountered in the cleaning of this type of scale is the great difficulty in dissolving aconitates, or aconitic acid salts. Aconitic acid is equivalent to dehydrated citric acid and is mainly found in trans form in cane sugar and beet sugar. Aconitic acid is found mainly in the form of tricalcium salts and of mixed dicalcium and magnesium salts, which are not commercially available.

However, still today, the literature describes only very little the problem linked to the difficulty in dissolving aconitates, one example being the elimination of these salts by washing with a solution of chelating agent such as EDTA salts, as previously indicated (cf. WO 2003/106735 or “Development of descriptor tools for the characterization of Australian sugar mill evaporator scale”, D. W. Rackemann et al., ibid., such that those skilled in the art are today aware only of the effectiveness of EDTA salts for eliminating deposits in the sugar industry.

EDTA is however today considered to possibly present risks with respect to the environment, in particular the aquatic environment, when it is used as a starting material for detergent products. In addition, the biodegradability of EDTA is less than 10% (cf. “European Union Risk Assessment Report, edetic acid (EDTA)”, PL-1, 49, (2004)).

According to the studies reported in “Chemical cleaning of sugar mill evaporators”, W. O. S. Doherty, Proc. Aust. Soc. Sugar Cane Technol., (2000), 22, 341-346, it is however learnt that dilute acids, such as sulfamic acid, hydrochloric acid and sulfuric acid, enable a slow attack of aconitic acid salts.

However, despite its effectiveness, hydrochloric acid (HCl) has numerous drawbacks, among which mention may be made of the release of toxic, nauseating, irritant, eye-watering vapors, and also problems of effluents because of the large amounts of chlorides discharged into the environment.

Moreover, because of its chemical nature, the concentration of HCl is limited to approximately 37%, whereas it might be advantageous, or even desirable, to have much higher acid concentrations in order to eliminate in particular all of the deposits that accumulate during sugar production.

Sulfuric acid is used only very little industrially, in particular because of its corrosive nature. Likewise, sulfamic acid, waste from which is considered to be harmful to the environment, in particular to aquatic organisms, is not an acid that can be widely used industrially.

Still other acids could be used, for instance phosphoric acid, the phosphate waste from which represents however a huge problem for the environment. Indeed, the use of phosphoric acid is today more than disputed, because of the phosphate waste that it produces.

It has also been envisioned to use organic acids, such as for example acetic acid, citric acid, oxalic acid, glycolic acid, lactic acid, formic acid, etc. However, since their acidity is lower than the abovementioned inorganic acids, they are less effective and require the use of large amounts of products.

In addition, some of the abovementioned acids are in solid form, which leads to difficulties in handling and formulation (pulverulent powders), and as a result are not preferred acids for the use of, the present invention. Furthermore, some of these organic acids are considered to be harmful. This is in particular the case with oxalic acid and glycolic acid.

The studies of D. W. Rackemann et al. (“Enhanced performance of caustic soda used for the removal of scale in sugar mill evaporators”, International Sugar Journal, (2008), 110, 344-349) teach that sodium hydroxide is ineffective for dissolving calcium salts, including calcium aconitate. In addition, the washing with sodium hydroxide must be followed by acid washing (phosphoric acid, formic acid, sulfamic acid, sulfuric acid, hydrochloric acid). However, this process is not very effective since the sodium hydroxide residues neutralize the acid and it is advised to replace the acid with EDTA.

Thus, a suitable formulation appears to be a formulation containing 13% of sodium hydroxide, 10% of EDTA and 2% of sodium gluconate. However, EDTA is not a product that can continue to be used, in particular for the reasons mentioned above.

There remains therefore a need for products, formulations and processes which make it possible to dispense with the drawbacks listed above, in particular a need for acids which make it possible to effectively eliminate the deposits observed in facilities used for sugar production, in particular from raw materials of plant origin and most particularly from sugar cane and from sugar beet, and more generally in facilities used for processes which carry out at least one step of evaporating the water from a mixture comprising at least one aconitic acid salt capable of depositing.

There especially remains a most particular need for products, formulations and processes which make it possible to rapidly and effectively dissolve aconitic acid salts, in particular magnesium and/or calcium salts of aconitic acid, while at the same time preserving the environment, that is to say products, formulations and processes which conform to the environmental and working standards in force, and which do not have the drawbacks associated in particular with the irritant releases of gas linked to the use of hydrochloric acid, or with the corrosive effects, in particular of sulfuric acid.

Thus, a first objective of the present invention consists in providing products and formulations which are effective for dissolving aconitic acid salts in particular, and more generally processes for cleaning the deposits encountered in sugar production facilities, in particular in the sugar industries.

Another objective of the present invention consists in providing an effective alternative to the acids commonly used in this application, while at the same time avoiding waste and effluents that are harmful to the environment, and also toxic and nauseating gas releases.

Still other objectives and advantages will emerge during the description of the present invention which follows, which invention makes it possible to totally or at least partially achieve the abovementioned objectives. Indeed, the applicant has now discovered that it is possible to effectively clean solid deposits comprising at least one aconitic acid salt, this being without having to use EDTA, EDTA salts or the strong organic acids known from the prior art.

In the description of the invention which follows, the term “cleaning” is intended to mean the eliminating and/or the dissolving of deposits comprising at least one aconitic acid salt, preferably a calcium and/or magnesium salt, this eliminating possibly being partial or total, preferably total, without having the abovementioned drawbacks, in particular the drawbacks regarding the environment, the drawbacks associated with releases of gas, and the like, as will now be described.

It has thus been discovered that it is possible to effectively clean solid deposits comprising at least one aconitic acid salt and usually encountered in industries which carry out at least one step of evaporating the water from a mixture comprising at least one aconitic acid salt capable of depositing, using a formulation based on at least one alkane sulfonic acid.

The formulations based on at least one alkane sulfonic acid have in particular an effectiveness that is at least equal, or even improved, with respect to hydrochloric acid which is the acid normally used in this field, or else with respect to ethylenediaminetetraacetic acid (EDTA) salts.

The alkane sulfonic acids have the advantage, on the one hand, of being less corrosive than hydrochloric acid, of not generating chlorides, of being biodegradable and of not giving off toxic or nauseating products, and also of being less pollutant than phosphoric acid, because of the phosphates discharged into the environment. In addition, the alkane sulfonic acids can be used in a more concentrated form than hydrochloric acid.

As already indicated, the use of the present invention has applications that are absolutely advantageous in industries which carry out at least one step of evaporating the water from a mixture comprising at least one aconitic acid salt capable of depositing, and in particular during the production of sugar from natural plant materials, for instance sugar cane or sugar beet.

This is because the formulations based on alkane sulfonic acid(s) are in particular easier to use and to handle compared with the products and formulations normally used for cleaning solid deposits comprising aconitic acid salts. This is because the use of formulations based on alkane sulfonic acid(s) produces few or no toxic, irritant or eye-watering gas releases.

Thus, and according to a first aspect, the present invention relates to the use of at least one alkane sulfonic acid of formula R—SO₃H, in which R represents a linear or branched, saturated hydrocarbon-based chain comprising from 1 to 4 carbon atoms, for cleaning solid deposits comprising at least one aconitic acid salt.

As previously indicated, this type of solid deposit is usually encountered in industries which carry out at least one step of evaporating the water from a mixture comprising at least one aconitic acid salt capable of depositing, and in particular during the production of sugar from natural plant materials, for instance sugar cane or sugar beet.

Thus, the invention relates to the use of at least one alkane sulfonic acid as active compound for cleaning solid deposits comprising at least one aconitic acid salt, said solid deposits usually being encountered in industries which carry out at least one step of evaporating the water from a mixture comprising at least one aconitic acid salt capable of depositing, and in particular during the production of sugar from natural plant materials, for instance sugar cane or sugar beet.

More particularly, the invention relates the use of at least one alkane sulfonic acid for cleaning surfaces soiled with solid deposits comprising at least one aconitic acid salt, on all types of surfaces.

Even more specifically, the present invention provides a formulation, capable particular of replacing the use of hydrochloric acid, for cleaning deposits comprising at least one aconitic acid salt, or more simply “aconitates” in the remainder of the present disclosure, said formulation comprising at least one alkane sulfonic acid which is an acid that is biodegradable, is not very toxic, releases few or no irritant or eye-watering gases, does not generate effluents that are harmful to the environment, and can be used in a more concentrated form than hydrochloric acid.

Aconitates, and in particular the aconitates encountered in the sugar industry, are well known to those skilled in the art and produce, in particular after numerous cycles of evaporation of the aqueous sugar solutions, more or less compact solid deposits. The aconitates encountered are mainly calcium and/or magnesium aconitates, and may be present in the solid deposits in combinations with other salts. As illustrative and nonlimiting examples of other salts that may be present in the solid deposits, mention may be made of carbonates, such as calcium carbonate, phosphates, such as tricalcium phosphate, hydroxyapatite, oxalates, such as calcium oxalate, sulfates, such as calcium sulfate, iron oxides, and the like.

The use of the present invention makes it possible to clean the aconitates, and more generally deposits comprising at least one aconitate, and which may be present on all types of surfaces, in particular hard surfaces, in particular metal (iron, aluminum, steel and the like), wood, polymer (plastic, paint, lacquer, varnish), glass, stone, ceramic, porcelain, terracotta surfaces, and the like.

For the purposes of the present invention, the term “cleaning” is intended to mean the cleaning, stripping, of all types of surfaces, as previously indicated, that are totally or partially soiled, coated or covered with residues, scales, deposits, that are dry or else wet, generated during the production of products obtained from plants and in particular from sugar cane or from sugar beet, by elimination, dissolution, of said residues, scales and deposits in general.

As previously indicated, the term “cleaning” also encompasses the partial or total elimination of solid deposits, comprising at least one aconitate, and which may have solidified, in an unforeseeable, undesirable or else undesired manner, in facilities comprising reactors, evaporators, containers, valves, pipes, tubes and the like, used during the production of sugar from natural plant materials, for instance sugar cane or sugar beet, and which are usually removed/eliminated by other chemical and/or mechanical means, such as brushes, trowels, shovels, pickaxes, hammers, pneumatic drills, and the like

In the present invention, the term “alkane sulfonic acid” is preferentially intended to mean the alkane sulfonic acids of formula R—SO₃H, in which R represents a linear or branched, saturated hydrocarbon-based chain comprising from 1 to 4 carbon atoms.

The alkane sulfonic acids that can be used in the context of the present invention are preferentially chosen from methanesulfonic acid, ethanesulfonic acid, n-propanesulfonic acid, iso-propanesulfonic acid, n-butanesulfonic acid, iso-butanesulfonic acid, sec-butanesulfonic acid, tert-butanesulfonic acid, and mixtures of two or more of them in any proportions.

According to one preferred embodiment, the alkane sulfonic acid used in the context of the present invention is methanesulfonic acid or ethanesulfonic acid; entirely preferably, the acid used is methanesulfonic acid.

Thus, the use according to the present invention employs at least one alkane sulfonic acid chosen from alkane sulfonic acids comprising a linear or branched chain comprising from 1 to 4 carbon atoms, and preferably at least methanesulfonic acid (MSA).

Said at least one alkane sulfonic acid that can be used in the context of the present invention can be used as it is, or in combination with one or more other components, that is to say in a formulation. Any type of formulation comprising at least one alkane sulfonic acid can be suitable. As a general rule, the formulation comprises from 0.01% to 100% by weight of alkane sulfonic acid, more generally from 0.05% to 90% by weight, in particular from 0.5% to 75% by weight, limits included, of alkane sulfonic acid(s), relative to the total weight of said formulation.

The formulation is for example an aqueous, organic or else aqueous-organic formulation. The formulation can be prepared in the form of a concentrated mixture, said concentrated mixture possibly being diluted by the final user. As a variant, the formulation can also be a ready-to-use formulation, that is to say that it does not need to be diluted. Finally, for the purposes of the present invention, the formulation can be a pure alkane sulfonic acid, or else a mixture of pure alkane sulfonic acids, that is to say that the formulation can contain only one or more sulfonic acids, without other formulation additive or other solvent or diluent.

The concentration of alkane sulfonic acid(s) in the formulation depends on numerous factors, among which mention may be made of the amount of deposits to be cleaned, the nature and the form of the surface to be cleaned, the temperature at which the formulation is applied, and the like. Those skilled in the art will know how to adjust the appropriate concentration of acid in the formulation without undue burden.

Concentrated solutions, for example of from 60% to 100%, preferably approximately 70% to 100% by weight of alkane sulfonic acid(s), relative to the total weight of said formulation, are thus preferred when it is desired to remove large amounts of deposits, or at the surface of materials that are not very sensitive to acid attacks. Less concentrated solutions of from 0.01% to 60%, preferably from 0.05% to 50% are preferred for smaller amounts of deposits to be eliminated, or for the cleaning of deposits that are still wet, and/or on surfaces that are sensitive to acid attacks.

Use may for example be made of the methanesulfonic acid in aqueous solution sold by the company Arkema under the name Scaleva®, or else under the name Lutropur° sold by the company BASF, ready to use or diluted in water in the proportions indicated above.

In addition to the alkane sulfonic acid(s), the formulation used in the present invention can optionally comprise one or more additives well known to those skilled in the art, such as those chosen from:
solvents, hydrotropic or solubilizing agents (for example alcohols, esters, ketones, amides, and the like),
biocides, disinfectants (bromoacetic acid, peracetic acid, aqueous hydrogen peroxide, and the like),
rheological or texturing or thickening or gelling agents (sugars, polysaccharides, alginates, silica, amorphous silica, gums, and the like),
organic or inorganic acids (for example sulfuric acid, phosphoric acid, nitric acid, sulfamic acid, acetic acid, citric acid, formic acid, lactic acid, glycolic acid, oxalic acid, and the like),
alkali metal salts, alkaline-earth metal salts, metal salts, in particular alkali metal and/or alkaline-earth metal fluorides, chlorides, iodides and bromides, preferably chlorides and fluorides, more preferably fluorides, in particular sodium fluoride or calcium fluoride,
flame retardants,
preservatives,
emulsifying anionic, cationic, non-ionic or amphoteric surfactants (such as ethoxylated alcohols and/or amines, alkyl and/or aryl sulfonates), detergents, soaps, and the like,
foaming agents, antifoams,
antifreezes (for example ethylene glycol, propylene glycol, and the like),
dyes,
corrosion inhibitors,
fragrances, odorizing agents,
and other additives known to those skilled in the art.

The formulation in aqueous form is particularly advantageous in “cleaning in place” (or else “CIP”) processes.

In addition, the use of alkane sulfonic acid(s), in particular of methanesulfonic acid, makes it possible to control the acid content, this being in order to be able to adjust as well as possible the acidity of the cleaning solution for optimal cleaning of reactors, pipes, evaporators, etc. This control of the acid content can be carried out according to any method known per se, and for example by conductivity.

According to one variant, the formulation is a formulation in gel form. It has in fact been observed that the formulations in the form of a gel of alkane sulfonic acid(s) are very effective for eliminating deposits comprising aconitates, as described previously, not only because of the gel itself which allows a longer action of the acid active ingredient (the gel “adheres” to the surfaces for longer, compared with an aqueous formulation), but also because the gel has an improved cleaning capacity, compared with other gel formulations.

Thus, according to another aspect, the present invention relates to the use of a formulation in gel form comprising:

from 0.01% to 97% by weight, preferably from 0.05% to 75% by weight and more particularly from 0.5% to 70% by weight, of at least one alkane sulfonic acid, preferably methanesulfonic acid;

from 0.1% to 30% by weight, preferably from 0.5% to 15% by weight and more particularly from 1% to 10% by weight, of at least one gelling agent;

from 0.1% to 30% by weight, preferably from 0.5% to 15% by weight, of at least one additive chosen from those mentioned above; and

the remainder to 100% of water and/or organic solvent, for cleaning solid deposits comprising at least one aconitic acid salt.

The gelling agents and the surfactants that can be used in the formulations in gel form may be of any type. Those skilled in the art will know, without particular difficulty and on the basis of the examples that follow, how to choose and adjust the nature of the gelling agents and surfactants that are appropriate.

According to another aspect, the present invention relates to the use of a formulation in foaming gel form. Foaming gels are in fact most particularly at advantageous because of the fact that they produce a tacky foam, in other words a foam that adheres to soiled surfaces, while at the same time generally requiring less consumption of cleaning acid active material, and having the advantage of being able to be rinsed off entirely effectively, that is to say of being able to be eliminated more simply and more effectively, while at the same time requiring a smaller amount of water.

Thus, the present invention also relates to the use of a formulation in foaming gel form comprising:

from 0.01% to 97% by weight, preferably from 0.05% to 75% by weight and more particularly from 0.5% to 70% by weight, of at least one alkane sulfonic acid, preferably methanesulfonic acid;

from 0.1% to 30% by weight, preferably from 0.5% to 15% by weight and more particularly from 1% to 10% by weight, of at least one foaming agent;

from 0% to 30% by weight, preferably from 0.5% to 15% by weight and more particularly from 1% to 10% by weight, of at least one gelling agent;

from 0% to 30% by weight, preferably from 0.5% to 15% by weight, of at least one additive chosen from those mentioned above, of which preferably from 0% to 10% by weight, preferably from 0.1% to 5% by weight, of a solubilizing or hydrotropic agent, and from 0% to 20% by weight, preferably from 0.5% to 10% by weight, of at least one surfactant; and

the remainder to 100% of water and/or organic solvent, for cleaning solid deposits comprising at least one aconitic acid salt.

According to the field and the method of application, the formulation can be prepared in the form of a concentrate, and then diluted before use until the expected effectiveness is obtained, with regard to the viscosity and to the foaming capacity.

In the foaming gel formulation above, the foaming agent can be chosen from the foaming agents commonly used by those skilled in the art, and preferably from amine oxides, for instance:

dimethylalkylamine oxides, the alkyl chain being a fatty “chain”, containing for example from 10 to 30 carbon atoms, preferably from 12 to 22 carbon atoms;

ethoxylated amine oxides; and

mixtures of two or more of them.

The use of at least one ethoxylated amine oxide, such as, in a nonlimiting manner, Cecajel® OX100 from the company CECA, or Aromox® T12 from the company Akzo, alone or in combination with at least one dimethylalkylamine oxide, makes it possible to provide the foaming gel with stability.

Foaming agents, and in particular those described above, generally form gels when they are mixed with water, that is to say that they increase the viscosity of the formulation, without it being necessary to add a gelling agent. However, the addition of such a gelling agent is not excluded from the present invention.

Among the solubilizing or hydrotropic agents that can be used in the formulations according to the invention, mention may be made, by way of example and in a nonlimiting manner, of sodium cumene sulfonate or sodium xylene sulfonate. However, such agents are not essential in the acid formulations according to the invention.

An aqueous, organic or aqueous-organic formulation, in the form of a solution or a gel or else in the form of a foaming gel, that is particularly preferred is a formulation comprising from 0.01% to 95%, preferably from 0.05% to 75%, more preferably from 0.5% to 50% by weight of methanesulfonic acid.

The formulations used according to the present invention, whether they are in liquid, gel or foaming gel form, concentrated or diluted, can be applied according to any method known to those skilled in the art, and in particular under pressure, or else by means of a spray gun.

The concentration of alkane sulfonic acid(s) can thus vary in very large proportions, depending on the nature and the amount of the residues to be eliminated, but also depending on the nature of the surfaces to be cleaned.

The invention also relates to a process for cleaning solid deposit comprising at least one aconitic acid salt, which aconitate deposit can be encountered in all types of industries which carry out at least one step of evaporating the water from a mixture comprising at least one aconitic acid salt capable of depositing, and in particular in industries where sugar is produced from natural plant materials, for instance sugar cane or sugar beet.

The present invention relates to a process for at least partially and preferably totally cleaning (i.e. solubilizing and/or eliminating) solid deposit comprising at least one aconitic acid salt, whether it is in wet or dried form, for example solidified form, and present on all types of surfaces, in particular hard surfaces, in particular metal (iron, aluminum, steel and the like), wood, polymer (plastic, paint, lacquer, varnish), glass, stone, ceramic, porcelain, terracotta surfaces, and the like.

Thus, the present invention relates to a process for eliminating deposits comprising at least one aconitic acid salt, as defined previously, present for example on all types of surfaces, as previously indicated, that are totally or partially soiled, coated or covered with residues, scales, deposits, that are dry or else wet, generated during the production of products obtained from plants and in particular from sugar cane or from sugar beet.

More particularly, the process of the present invention comprises at least one step of bringing an effective amount of at least one alkane sulfonic acid, as defined previously, preferably methanesulfonic acid, in the form of an aqueous, organic or aqueous-organic formulation, in solution, gel or foaming gel form, as have just been described, into contact with a solid deposit comprising at least aconitic acid to be eliminated, by contact, immersion, sprinkling, spraying, application of a more or less thick layer, optionally by means of appropriate tools known to those skilled in the art (fine brushes, brushes, spatulas, and the like), said contacting step being optionally followed by one or more rinsing and/or drying steps.

The temperature at which the process, and in particular the contacting step, is carried out can vary in large proportions and is generally between −20° C. and +150° C., preferably between 0° C. and 80° C., more preferably between 10° C. and 80° C. According to one preferred embodiment, the temperature for use is ambient temperature or else a temperature between ambient temperature and approximately 80° C.

It can thus be envisioned to bring to temperature the alkane sulfonic acid and the surface to be treated, these temperatures possibly being identical or different, or else to bring to temperature either the alkane sulfonic acid or the surface to be treated.

It is thus possible to treat, outside, surfaces soiled with solid deposits at ambient temperature (for example 10° C.) by means of a formulation of alkane sulfonic acid(s) that is brought to 70° C., or else to treat surfaces soiled with solid deposits at a high temperature (for example approximately 100° C.) by means of a formulation of alkane sulfonic acid(s) at ambient temperature (for example 20° C.). It can also be envisioned to totally immerse the surfaces to be treated in a formulation of alkane sulfonic acid(s) that is brought for example to a temperature of approximately 60° C., for example in order to eliminate solid deposits present in valves, tubes, and the like.

In the process of the invention, it should be understood that it is possible to use at least one alkane sulfonic acid or any formulation comprising at least one alkane sulfonic acid, as previously described.

Finally, after the step of treatment(s), by bringing into contact, and then of optional rinsing(s), the cleaned surface can, where appropriate and if necessary, be dried, according to any method known to those skilled in the art, for example in the air, under a stream of more or less hot air, in an oven, by heating (electric, heating lamps), wiping (absorbent papers or textiles), and the like.

As previously indicated, the alkane sulfonic acid is advantageously used in the form of a formulation, for example an aqueous, organic or aqueous-organic formulation, in liquid, gel or foaming gel form, as previously described.

In the process of the invention as it has just been described, the term “effective amount” is intended to mean an amount which makes it possible to clean the residues, scales and in general solid deposits comprising at least one aconitic acid salt.

This amount can vary in large proportions, depending on the surfaces to be treated and the amount of solid deposits, on the temperature and on the pressure of the formulation used, on the desired duration of the cleaning process, and the like.

Thus, the amount of acid will advantageously be established so as to allow complete cleaning, or cleaning that is as complete as possible, of the solid deposits of aconitates, while at the same time using a minimal amount of acid(s), essentially for economic reasons.

This operation of cleaning the solid deposits of aconitates can be repeated one or more times depending on the amount and the nature of the solid deposits, and the degrees of encrustation thereof on the surfaces to be treated.

The bringing into contact of an effective amount of at least one alkane sulfonic acid is followed by a reaction time required for the dissolving of the solid deposits that it is desired to eliminate, this reaction time possibly ranging from a few seconds to a few hours, or even a few days, depending on the temperature at which the cleaning is carried out, the pressure at which the alkane sulfonic acid(s) is (are) applied, the nature of the formulation comprising said at least one alkane sulfonic acid, the amount of deposits to be eliminated, the degrees of encrustation thereof, and also the nature of the surfaces to be treated.

The treatment with at least one alkane sulfonic acid as it has just been defined can optionally be accompanied and/or preceded and/or followed by one or more washes, and preferably preceded by one or more pre-washes, if necessary, using a basic formulation comprising at least one inorganic or organic base, preferably an inorganic base, for example an alkali metal or alkaline-earth metal hydroxide, for example sodium hydroxide, in any concentrations. These basic washes are entirely preferably carried out before, or after, or even before and after, but preferably not simultaneously with, the cleaning with said at least one alkane sulfonic acid, this being in order to avoid the acid/base neutralization reactions that might be harmful to the quality of the cleaning desired.

The treatment with at least one alkane sulfonic acid as it has just been defined can also be accompanied and/or followed by one or more mechanical operations (stirring, scraping, brushing, and the like), in order to improve the chemical acid action, if necessary.

As previously indicated, the treatment can be followed by one or more rinsing operations, for example with clear water, solvent(s) or water/solvent mixture(s).

In the process of the invention as it has just been described, the term “effective amount” is intended to mean an amount which makes it possible to dissolve and eliminate all or part of the dirt, residues, scales, which may or may not be dry, of solid deposits comprising at least one aconitic acid salt.

This amount can vary in large proportions, depending on the surfaces to be treated and the amount of solid deposits, on the temperature, on the pressure of the formulation used, on the nature of the formulation used, on the desired duration of the eliminating process, and the like.

Thus, the amount of acid will advantageously be adjusted so as to allow total or at least partial elimination, preferably total elimination, of the residues or scales, which may or may not be dried, of said solid deposits of aconitates, while at the same time keeping to a minimal amount of acid(s), essentially for economic reasons.

The alkane sulfonic acids, in particular methanesulfonic acid, have shown themselves to be effective for cleaning solid deposits of aconitates, and most particularly solid deposits encountered in the industry for producing sugar, in particular from sugar cane or sugar beet, without generating irritant and eye-watering gas releases.

Moreover, the use of at least one alkane sulfonic acid according to the present invention has the advantage of only generating little, or even no, corrosion, in particular during the cleaning of metal surfaces (of which there are many in particular in the sugar industries), which corrosion is frequently observed on said metal surfaces when solutions of more or less concentrated acids are used.

The alkane sulfonic acids can also be used at high concentrations, in order to increase their effectiveness, which concentrations may be 50%, 70%, or even 100% by weight, whereas the maximum concentration of hydrochloric acid can at most only be 37%, because of the intrinsic chemical nature of this acid.

In addition, the alkane sulfonic acids used in the present invention have, compared with arylsulfonic acids, the advantage of generating a lower chemical oxygen demand (COD) in effluent treatment plants, and consequently of allowing a stronger concentration of organic waste in said plants.

The formulations that can be used in the context of the present invention can contain phosphorus-comprising compounds, for instance phosphates, originating for example from phosphoric acid, but in low proportions, for example less than 10% by weight, preferably less than 5% by weight, more preferably less than 1% by weight, relative to the total weight of the formulation, always with the aim of minimizing as much as possible the waste harmful to the environment.

In addition, the formulations that can be used in the context of the present invention can contain sulfur-comprising compounds, for instance sulfates, originating for example from sulfuric acid, but in low proportions, for example less than 10% by weight, preferably less than 5% by weight, more preferably less than 1% by weight, relative to the total weight of the formulation.

The formulations that can be used in the context of the present invention can contain chlorinated compounds, for instance chlorides, originating for example from hydrochloric acid, but in low proportions, for example less than 10% by weight, preferably less than 5% by weight, more preferably less than 1% by weight, relative to the total weight of the formulation.

The formulations that can be used in the context of the present invention can contain nitrogenous compounds, for instance nitrates, originating for example from nitric acid, but in low proportions, for example less than 10% by weight, preferably less than 5% by weight, more preferably less than 1% by weight, relative to the total weight of the formulation.

The present invention described above shows that it is possible to eliminate the solid deposits of aconitates on all types of surfaces, such as, and in a nonlimiting manner, metal (iron, steel, copper, alloy, and the like), concrete, cement, tiling, porcelain, wood, paper, cardboard, textile, polymer (plastic, varnish, paint, lacquer), glass surfaces, and the like.

The present invention also shows that it is possible to clean the undesirable residues, which may or may not be dried, from said surfaces, but also to eliminate the solid deposits which may have solidified in various containers, evaporators, tubes, valves, and the like, and which are usually eliminated by acids that are not very environmentally friendly and/or that are corrosive with respect to the surfaces to be treated.

Thus, the alkane sulfonic acids can advantageously be used as a replacement for the acids commonly known and used by those skilled in the art for eliminating solid deposits of aconitates, in a large number of application fields, among which mention may be made, in a nonlimiting manner, of the sugar industries.

It should be understood that the use according to the present invention makes it possible not only to clean the solid deposits of aconitates, but also and concomitantly to clean other type(s) of dirt that may be present on the surfaces to be treated, owing to the acid nature of the alkane sulfonic acids used.

For example, the alkane sulfonic acids used in the context of the present invention can prove to be effective for cleaning any type of dirt, such as rust or scale, but also any type of organic dirt inherent in the production in particular of sugar from plants, as previously indicated.

The present invention is now illustrated by means of the examples which follow, which are in no way limiting in nature, and which consequently cannot be understood to restrict the scope of the invention as claimed.

In order to assess the effectiveness of the alkane sulfonic acids in the cleaning of deposits comprising aconitic acid salts, a calcium salt of aconitic acid is first of all prepared, and then dissolution tests are carried out.

### EXAMPLE 1

Preparation of Tricalcium Aconitate Trihydrate: Ca₃(C₆H₃O₆)₂.3H₂O

This preparation is described in the thesis by Niconor Niconey Reece, University of Louisiana; December 2003, “Optimizing aconitate removal during clarification”.

8 g of trans-aconitic acid (0.0457 mol, molecular weight=174) are introduced into a 500 ml four-necked flask equipped with a magnetic bar, with a water condenser, with a temperature probe and with a pH probe. This is then made up to 133 g with ultrapure water. The solution is then neutralized with 0.2 M potassium hydroxide to pH 11.3, then the pH is adjusted to the value of 6 with a 1 N hydrochloric acid (HCl) solution.

The solution is then heated to 85° C., and then 228.5 ml of a 0.3 M calcium chloride solution, the pH of which has been adjusted beforehand to 6 with 1 N HCl, are added.

The reaction medium is heated for 3 hours at 85° C. and a precipitate then appears, the medium is then filtered while hot. 10.6 g of a solid are recovered, and washed 3 times with 30 ml of hot water.

After oven-drying under a vacuum of 50 mbar for 48 hours at ambient temperature, 7.4 g of a white solid are obtained, and said solid is characterized by analyses of its carbon, hydrogen and calcium contents, which are in accordance with the formula Ca₃(C₆H₃O₆)₂.3(H₂O).

### Measurement of the Solubility of the Tricalcium Aconitate Trihydrate

30 g of 1 M aqueous acid solution are introduced into a 50 ml three-necked flask equipped with a magnetic stirrer, with a condenser and with a temperature probe. The salt prepared as indicated above (tricalcium aconitate trihydrate) is then added in portions of approximately 0.1 g, until undissolved crystals appear (saturation of the medium).

The percentage of salt dissolved is calculated according to the following formula:

% salt dissolved=w/(W+w)

where W represents the weight of acid solution, and w represents the weight of salt introduced.

Table 1 below collates the results of dissolution of the tricalcium aconitate trihydrate at 20° C.

TABLE 1

| | % by weight of tricalcium aconitate |
|---|---|
| | trihydrate dissolved at ambient |
| acid tested | temperature (20° C.) |
| methanesulfonic acid | 12.1% |
| hydrochloric acid | 12.1% |
| sulfamic acid | 11.9% |
| sulfuric acid | <<2.2% |

Sulfuric acid is not very effective with respect to the solubility of the aconitic acid salts. Methanesulfonic acid exhibits, surprisingly, an effectiveness comparable to that of hydrochloric acid and slightly better than that of sulfamic acid. Methanesulfonic acid is however much less corrosive than hydrochloric acid, the released vapors of which are irritant and toxic to the user. Furthermore, methanesulfonic acid is biodegradable.

Finally, sulfamic acid, waste from which is also considered to be harmful to the environment, in particular to aquatic organisms, is not an acid that can be widely used industrially.

1. A process for cleaning, from a surface, solid deposits to be eliminated, wherein the solid deposits comprise at least one aconitic acid salt, wherein the process comprises the steps of: a) bringing at least one alkane sulfonic acid of formula R—SO₃H, in which R represents a linear or branched, saturated hydrocarbon-based chain comprising from 1 to 4 carbon atoms, into contact with the solid deposits comprising at least one aconitic acid salt, and b) allowing the at least one alkane sulfonic acid to dissolve the solid deposits comprising at least one aconitic acid salt, thereby eliminating the solid deposits from the surface.

2. The process according to claim 1, wherein the alkane sulfonic acid is selected from the group consisting of methanesulfonic acid, ethanesulfonic acid, n-propanesulfonic acid, iso-propanesulfonic acid, n-butanesulfonic acid, iso-butanesulfonic acid, sec-butanesulfonic acid, tert-butanesulfonic acid, and mixtures thereof.

3. The process according to claim 2, wherein the alkane sulfonic acid is methanesulfonic acid or ethanesulfonic acid.

4. The process according to claim 1, wherein the at least one alkane sulfonic acid is in the form of a formulation, wherein the formulation comprises from 0.01% to 100% of the alkane sulfonic acid relative to the total weight of the formulation.

5. The process according to claim 4, wherein the formulation is aqueous, or organic, or aqueous-organic, or is ready to use, or is concentrated to be diluted before use.

6. The process according to claim 4, wherein the formulation further comprises one or more additives selected from the group consisting of:
solvents, hydrotropic agents, solubilizing agents, gelling agents,
biocides, disinfectants, bromoacetic acid, peracetic acid, aqueous hydrogen peroxide,
rheological agents, texturing agents, thickening agents,
organic acids, inorganic acids
flame retardants,
preservatives,
emulsifying anionic surfactants, cationic surfactants, non-ionic surfactants, amphoteric surfactants, ethoxylated alcohols,
foaming agents, antifoams,
antifreezes,
corrosion inhibitors,
dyes,
fragrances, odorizing agents,
and mixtures thereof.

7. The process according to claim 4, wherein the at least one alkane sulfonic acid is used in liquid, gel or foaming gel formulation.

8. The process according to claim 1, wherein the step a) comprising bringing the at least one alkane sulfonic acid into contact with the solid deposits to be eliminated, comprises at least one of contact, immersion, sprinkling, spraying, application of a layer, of the alkane sulfonic acid with the solid deposits to be eliminated, optionally by means of appropriate tools.

9. The process according to claim 8, wherein the step a) is carried out at a temperature of between −20° C. and +150° C.

10. The process according to claim 1, wherein the surface comprises at least one of metal, concrete, cement, tiling, tile, stone, porcelain, wood, paper, cardboard, textile, polymer, plastic, varnish, paint, lacquer, or glass surfaces.

11. The process according to claim 1, wherein the step b) is followed by one or more steps of rinsing and/or drying the surface.
